(19) United States
(12) Patent Application Publication
(10) Pub. No.: US 2024/0291588 A1
(43) Pub. Date: Aug. 29, 2024

(54) DATA TRANSMISSION METHOD AND APPARATUS

(71) Applicant: HUAWEI TECHNOLOGIES CO., LTD., Shenzhen (CN)

(72) Inventors: Chenchen LIU, Shenzhen (CN); Xun YANG, Shenzhen (CN)

(21) Appl. No.: 18/659,114

(22) Filed: May 9, 2024

Related U.S. Application Data
(63) Continuation of application No. PCT/CN2022/130278, filed on Nov. 7, 2022.

(30) Foreign Application Priority Data
Nov. 10, 2021 (CN) 202111329453.5

(51) Int. Cl. H04L 1/00

(52) U.S. Cl. CPC H04L 1/0036; H04L 1/0033; H04L 1/0057

(57) ABSTRACT

An example data transmission method includes: generating a physical layer protocol data unit (PPDU), where the PPDU includes a physical layer payload field, the physical layer payload field is used to carry a first data bit, and the first data bit is determined based on a first mapping relationship and a to-be-transmitted data bit; and sending the PPDU. The data transmission method can improve a data transmission rate and enhance transmission performance of a system. A corresponding example data receiving method, and apparatuses are also described.

### CROSS-REFERENCE TO RELATED APPLICATIONS

This application is a continuation of International Application No. PCT/CN2022/130278, filed on Nov. 7, 2022, which claims priority to Chinese Patent Application No. 202111329453.5, filed on Nov. 10, 2021. The disclosures of the aforementioned applications are hereby incorporated by reference in their entireties.

### TECHNICAL FIELD

This application relates to the field of wireless communication, and more specifically, to a data transmission method and apparatus.

### BACKGROUND

With development of the mobile internet, popularization of intelligent terminals, and rapid growth of data traffic, a user has an increasingly high requirement on communication service quality. As a wireless carrier communication technology, an ultra-wideband (UWB) technology is widely applied to the field of short-distance and high-rate wireless communication due to characteristics such as a strong multipath resolution capability, low power consumption, and strong confidentiality.

Currently, the UWB technology transmits data by sending and receiving ultra-narrow pulses in nanoseconds or less, and modulates different information based on a pulse position and a pulse polarity. However, an actual transmission rate at a highest mean pulse repetition frequency (PRF) is still low, and cannot adapt to many high-rate application scenarios.

Therefore, how to improve the data transmission rate and enhance transmission performance of such systems is an urgent problem to be resolved.

### SUMMARY

This application provides a data transmission method and apparatus, to improve a data transmission rate and enhance transmission performance of a system.

According to a first aspect, a data transmission method is provided. The method may be performed by a sending device (for example, a sending end), or may be performed by a chip or a circuit of the sending device. This is not limited in this application. For ease of description, an example in which the method is performed by the sending end is used below for description.

The method includes: generating a physical layer protocol data unit (PHY protocol data unit, PPDU), where the PPDU includes a physical layer payload field, the physical layer payload field is used to carry a first data bit, and the first data bit is determined based on a first mapping relationship and a to-be-transmitted data bit; and sending the PPDU.

According to the solution provided in this application, the sending end obtains the first data bit by mapping the to-be-transmitted data bit based on the first mapping relationship, and encodes different to-be-transmitted data bits based on the first mapping relationship, to implement information modulation, thereby improving a data transmission rate and transmission performance of a communication system.

According to a second aspect, a data transmission method is provided. The method may be performed by a receiving device (for example, a receiving end), or may be performed by a chip or a circuit of the receiving device. This is not limited in this application. For ease of description, an example in which the method is performed by the receiving end is used below for description.

The method includes: receiving a physical layer protocol data unit (PPDU), where the PPDU includes a physical layer payload field, the physical layer payload field is used to carry a first data bit, and the first data bit is determined based on a first mapping relationship and a to-be-transmitted data bit; and parsing, the to-be-transmitted data bit based on the first data bit and the first mapping relationship.

According to the solution provided in this application, the receiving end parses, the to-be-transmitted data bit based on the first data bit and the first mapping relationship, and decodes different first data bits based on the first mapping relationship, to implement information modulation, thereby improving a data transmission rate and transmission performance of a communication system.

With reference to the first aspect or the second aspect, in some implementations, the first mapping relationship is determined based on a row of a Hadamard matrix, and the Hadamard matrix is a matrix with n rows and n columns.

In this implementation, the to-be-transmitted data bit is mapped to a row of the Hadamard matrix to obtain n encoded bits, and then elements in the row are mapped to a pulse sequence, and transmitted in a pulse form, to finally implement information modulation.

With reference to the first aspect or the second aspect, in some implementations, the Hadamard matrix includes a first submatrix, the first submatrix is a circulant matrix with n−1 rows and n−1 columns, elements in an (i+1)^{th} column of the first submatrix are obtained by cyclically shifting elements in an (i)^{th} column to the right by one position in sequence, and i is an integer greater than or equal to 1 and less than or equal to n−2. A row vector of each row of the first submatrix is determined based on a first sequence or an equivalent sequence of a first sequence, and the equivalent sequence is obtained by performing at least one of cyclic shifting, negation, and order reversal on the first sequence.

With reference to the first aspect or the second aspect, in some implementations, the first mapping relationship is a specific type of linear block code.

With reference to the first aspect or the second aspect, in some implementations, the linear block code includes Hamming code and/or single error correction and double error detection (SECDED) code.

In this implementation, the to-be-transmitted data bit is encoded by using the linear block code, and then an encoded first data bit is mapped to a pulse sequence, and transmitted in a pulse form, to finally implement information modulation. In addition, using the Hamming code and/or the single error correction and double error detection SECDED code can also improve an error correction capability of a system and enhance robustness of the system.

With reference to the first aspect or the second aspect, in some implementations, when a scrambling code bit is 1, all bits in the first data bit are negated.

In this implementation, one scrambling code bit corresponds to one first data bit, and the first data bit is scrambled by using a small quantity of scrambling code bits, to ensure data transmission security.

Optionally, one scrambling code bit may further correspond to a bit in the first data bit. For example, when the scrambling code bit is 1, the bit in the first data bit is negated.

According to a third aspect, a data transmission apparatus is provided, including: a processing unit, configured to generate a PPDU, where the PPDU includes a physical layer payload field, the physical layer payload field is used to carry a first data bit, and the first data bit is determined based on a first mapping relationship and a to-be-transmitted data bit; and a transceiver unit, configured to send the PPDU.

According to a fourth aspect, a data transmission apparatus is provided, including: a transceiver unit, configured to receive a PPDU, where the PPDU includes a physical layer payload field, the physical layer payload field is used to carry a first data bit, and the first data bit is determined based on a first mapping relationship and a to-be-transmitted data bit; and a processing unit, configured to parse the to-be-transmitted data bit based on the first data bit and the first mapping relationship.

With reference to the third aspect or the fourth aspect, in some implementations, the first mapping relationship is determined based on a row of a Hadamard matrix, and the Hadamard matrix is a matrix with n rows and n columns.

In this implementation, the to-be-transmitted data bit is mapped to a row of the Hadamard matrix to obtain n encoded bits, and then elements in the row are mapped to a pulse sequence, and transmitted in a pulse form, to finally implement information modulation.

With reference to the third aspect or the fourth aspect, in some implementations, the Hadamard matrix includes a first submatrix, the first submatrix is a circulant matrix with n−1 rows and n−1 columns, elements in an (i+1)^{th} column of the first submatrix are obtained by cyclically shifting elements in an (i)^{th} column to the right by one position in sequence, and i is an integer greater than or equal to 1 and less than or equal to n−2. A row vector of each row of the first submatrix is determined based on a first sequence or an equivalent sequence of a first sequence, and the equivalent sequence is obtained by performing at least one of cyclic shifting, negation, and order reversal on the first sequence.

With reference to the third aspect or the fourth aspect, in some implementations, the first mapping relationship is a specific type of linear block code.

With reference to the third aspect or the fourth aspect, in some implementations, the linear block code includes Hamming code and/or single error correction and double error detection (SECDED) code.

In this implementation, the to-be-transmitted data bit is encoded by using the linear block code, and then an encoded first data bit is mapped to a pulse sequence, and transmitted in a pulse form, to finally implement information modulation. In addition, using the Hamming code and/or the SECDED code can also improve an error correction capability of a system and enhance robustness of the system.

With reference to the third aspect or the fourth aspect, in some implementations, the processing unit is further configured to: when a scrambling code bit is 1, negate all bits in the first data bit.

In this implementation, one scrambling code bit corresponds to one first data bit, and the first data bit is scrambled by using a small quantity of scrambling code bits, to ensure data transmission security.

Optionally, one scrambling code bit may further correspond to a bit in the first data bit.

According to a fifth aspect, a communication apparatus is provided, including a processor, and optionally, further including a memory, where the processor is configured to control a transceiver to receive and send a signal, the memory is configured to store a computer program, and the processor is configured to invoke and run the computer program from the memory, so that a sending device performs the method according to the first aspect or any one of the possible implementations of the first aspect.

Optionally, there are one or more processors, and there are one or more memories.

Optionally, the memory may be integrated with the processor, or the memory and the processor are separately disposed.

Optionally, the sending device further includes a transceiver. The transceiver may be specifically a transmitter machine (transmitter) and a receiver machine (receiver).

According to a sixth aspect, a communication apparatus is provided, including a processor, and optionally, further including a memory, where the processor is configured to control a transceiver to receive and send a signal, the memory is configured to store a computer program, and the processor is configured to invoke and run the computer program from the memory, so that a receiving device performs the method according to the second aspect or any one of the possible implementations of the second aspect.

Optionally, there are one or more processors, and there are one or more memories.

Optionally, the memory may be integrated with the processor, or the memory and the processor are separately disposed.

Optionally, the receiving device further includes a transceiver. The transceiver may be specifically a transmitting machine (transmitter) and a receiving machine (receiver).

According to a seventh aspect, a communication system is provided, including a sending device, configured to perform the method according to the first aspect or any one of the possible implementations of the first aspect, and a receiving device, configured to perform the method according to the second aspect or any one of the possible implementations of the second aspect.

According to an eighth aspect, a computer-readable storage medium is provided. The computer-readable storage medium stores a computer program or code. When the computer program or the code is run on a computer, the computer is enabled to perform the method according to the first aspect or any one of the possible implementations of the first aspect, or the method according to the second aspect or any one of the possible implementations of the second aspect.

According to a ninth aspect, a chip is provided, including at least one processor, where the at least one processor is coupled to a memory, the memory is configured to store a computer program, and the processor is configured to invoke and run the computer program from the memory, so that a sending device installed with the chip system performs the method according to the first aspect or any one of the possible implementations of the first aspect, and a receiving device installed with the chip system performs the method according to the second aspect or any one of the possible implementations of the second aspect.

The chip may include an input circuit or interface configured to send information or data, and an output circuit or interface configured to receive information or data.

According to a tenth aspect, a computer program product is provided. The computer program product includes computer program code, and when the computer program code is run by a sending device, the method according to the first aspect or any one of the possible implementations of the first aspect is performed, and when the computer program code is run by a receiving device, the method according to the second aspect or any one of the possible implementations of the second aspect is performed.

### BRIEF DESCRIPTION OF DRAWINGS

FIG. 1 is a schematic diagram of an example of a communication system applicable to this application;

FIG. 2 is a schematic diagram of an example of a structure of a PPDU in ultra-wideband applicable to this application;

FIG. 3 is a schematic diagram of an example of a transmission interval of a data bit applicable to this application;

FIG. 4 is a schematic diagram of an example of a structure of a convolutional code encoder in a UWB system applicable to this application;

FIG. 5 is a schematic diagram of an example of a structure of a scrambler applicable to this application;

FIG. 6 is a schematic diagram of an example of a data transmission method applicable to this application;

FIG. 7 is a schematic diagram of an example of transmission intervals of data bits that are obtained through mapping of a Hadamard matrix applicable to this application;

FIG. 8 is a schematic diagram of an example of a data transmission apparatus applicable to this application;

FIG. 9 is a schematic diagram of another example of a data transmission apparatus applicable to this application; and

FIG. 10 is a schematic diagram of another example of a data transmission apparatus applicable to this application.

### DESCRIPTION OF EMBODIMENTS

The following describes technical solutions of this application with reference to accompanying drawings.

Embodiments of this application may be applied to a wireless personal area network (WPAN). Currently, the Institute of Electrical and Electronics Engineers (IEEE) 802.15 series is a standard used for the WPAN. The WPAN can be used for communication between digital auxiliary devices within a small range such as telephones, computers, and auxiliary devices, and a working range is usually within 10 m. Technologies that support the wireless personal area network include Bluetooth, ZigBee, ultra-wideband (UWB), an IrDA infrared connection technology (infrared), HomeRF, and the like. In terms of a network structure, the WPAN is located at a bottom layer of an entire network architecture, is used for wireless connections between devices within a small range, that is, point-to-point short-distance connections, and can be regarded as a short-distance wireless communication network. Based on different application scenarios, the WPAN is further classified into a high rate (HR)-WPAN and a low rate (LR)-WPAN. The HR-WPAN can be used to support various high rate multimedia applications, including high-quality audio-visual transmission, multi-megabyte music, image document transmission, and the like. The LR-WPAN can be used for a common service in daily life.

In the WPAN, a device may be classified into a full-function device (FFD) and a reduced-function device (RFD) based on a communication capability of the device. FFD devices can communicate with each other, and an FFD device and an RFD device can communicate with each other. RFD devices cannot directly communicate with each other, and can only communicate with the FFD device, or forward data externally through one FFD device. The FFD device associated with the RFD is referred to as a coordinator of the RFD. The RFD device is mainly used for simple control applications, for example, a light switch or a passive infrared sensor. The RFD device transmits a small amount of data, occupies few transmission resources and communication resources, and has low costs. The coordinator may also be referred to as a personal area network (PAN) coordinator, a central control node, or the like. The PAN coordinator is a main control node of the whole network, and each ad hoc network has only one PAN coordinator, which has functions of member identity management, link information management, and packet forwarding. Optionally, the device in embodiments of this application may be a device that supports a plurality of WPAN standards, such as 802.15.4a, 802.15.4z, and a currently under discussion version or a subsequent version.

In embodiments of this application, the device may be a communication server, a router, a switch, a bridge, a computer or a mobile phone, a smart home device, a vehicle-mounted communication device, or the like.

In embodiments of this application, the device includes a hardware layer, an operating system layer running above the hardware layer, and an application layer running above the operating system layer. The hardware layer includes hardware such as a central processing unit (CPU), a memory management unit (MMU), and a memory (also referred to as a main memory). An operating system may be any one or more types of computer operating systems that implement service processing through a process, for example, a Linux operating system, a Unix operating system, an Android operating system, an iOS operating system, or a Windows operating system. An application layer includes applications such as a browser, an address book, word processing software, and instant messaging software. In addition, a specific structure of an execution body of the method provided in embodiments of this application is not specially limited in embodiments of this application, provided that a program that records code of the method provided in embodiments of this application can be run to perform communication according to the method provided in embodiments of this application. For example, the method provided in embodiments of this application may be performed by the FFD or the RFD, or a functional module that can invoke and execute the program in the FFD or the RFD.

In addition, aspects or features of this application may be implemented as a method, an apparatus, or a product that uses standard programming and/or engineering technologies. A term “product” used in this application covers a computer program that can be accessed from any computer-readable component, carrier, or medium. For example, the computer-readable medium may include but is not limited to: a magnetic storage component (for example, a hard disk, a floppy disk, or a magnetic tape), an optical disc (for example, a compact disc, a digital versatile disc (DVD)), a smart card, and a flash storage device (for example, an erasable programmable read-only memory (EPROM), a card, a stick, or a key drive). In addition, various storage media described in this specification may indicate one or more devices and/or other machine-readable media that are configured to store information. A term “machine-readable media” may include but is not limited to a radio channel, and various other media that can store, include, and/or carry instructions and/or data.

Embodiments of this application may be further applied to a wireless local area network system, for example, an internet of things (IoT) or vehicle-to-X (V2X) network. Certainly, embodiments of this application may be further applied to other possible communication systems, for example, a long term evolution (LTE) system, an LTE frequency division duplex (FDD) system, LTE time division duplex (TDD), a universal mobile telecommunications system (UMTS), a worldwide interoperability for microwave access (WiMAX) communication system, a 5th generation (5G) communication system, and a future 6th generation (6G) communication system.

The communication systems applicable to this application are merely examples for description, and communication systems applicable to this application are not limited thereto. This is stated herein once for all, and is not repeated below.

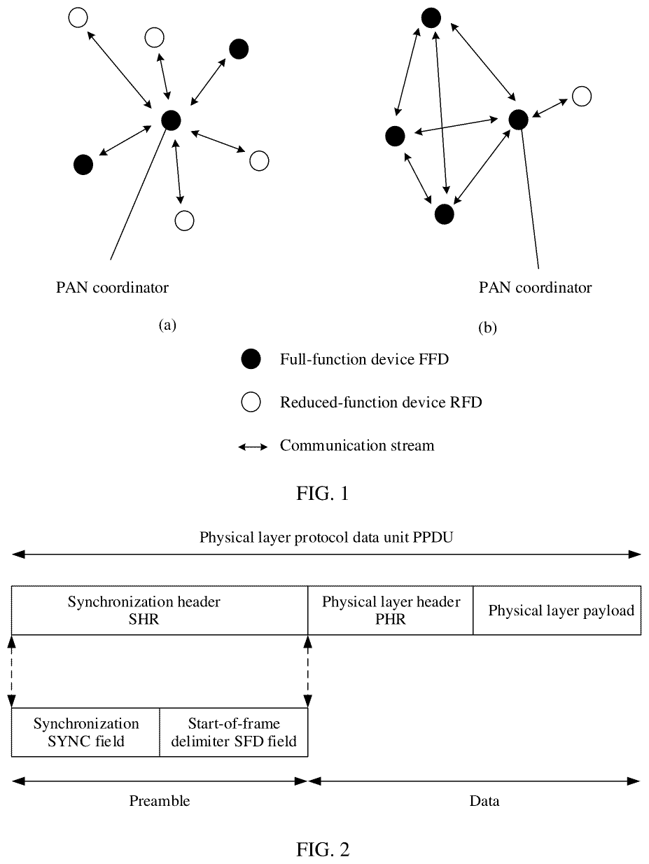

For ease of understanding embodiments of this application, a communication system shown in FIG. 1 is first used as an example to describe in detail a communication system applicable to embodiments of this application. A system architecture shown in FIG. 1 may be a star topology or a point-to-point topology structure. In the star topology (for example, (a) in FIG. 1), a plurality of FFDs and a plurality of reduced-function devices RFDs are included. One FFD serves as a PAN coordinator, and may perform data transmission with one or more other FFDs, or may perform data transmission with one or more other RFDs. In other words, one central control node may perform data communication with one or more other devices, and a plurality of devices may establish a one-to-many or many-to-one data transmission architecture. In the point-to-point topology structure (for example, (b) in FIG. 1), a plurality of full-function devices FFDs and one reduced-function device RFD are included. One FFD serves as a PAN coordinator, and may perform data transmission with one or more other FFDs, or may perform data transmission with another RFD. RFDs may transmit data to each other. In other words, different devices may communicate with each other, and a many-to-many data transmission architecture may be established between the plurality of different devices.

In embodiments of this application, a core apparatus and a core product include but are not limited to a central control point like a communication server, a router, a switch, a bridge, a computer, or a mobile phone, a PAN, and a PAN coordinator. The PAN includes a transceiver, configured to transmit/receive a packet structure, a memory, configured to store signaling information, a preset value agreed in advance, and the like, and a processor, configured to parse signaling information, process related data, and the like.

It should be understood that FIG. 1 is merely an example of a simplified schematic diagram for ease of understanding, and does not constitute a limitation on an application scenario of this application. For example, the system may further include another FFD and/or RFD and the like.

As a UWB technology enters the civil field, ultra-wideband wireless communication becomes one of popular physical layer technologies in a short-distance and high-speed wireless network. Many world-renowned companies, research institutions, and standardization organizations are actively engaged in research, development and standardization of ultra-wideband wireless communication technologies. The IEEE incorporates the UWB technology into the IEEE 802 series wireless standards of the IEEE, and publishes the UWB technology-based high-speed WPAN standard IEEE 802.15.4a and an evolved version IEEE 802.15.4z of the standard IEEE 802.15.4a. At present, formulation of the next generation UWB WPAN standard 802.15.4ab is put on the agenda.

FIG. 2 is a schematic diagram of an example of a structure of a PPDU in a UWB communication system applicable to this application. As shown in FIG. 2, the PPDU includes two parts: a preamble and data. The preamble part includes a synchronization header (SHR), and the SHR includes a synchronization (SYNC) field and a start-of-frame delimiter (SFD) field. The data part includes a physical layer header (PHY Header, PHR) and a PHY payload field.

The SHR is used by a receiving end to perform PPDU detection and synchronization, and the receiving end may detect, based on the SHR, whether a sending end sends the PPDU and a start location of the PPDU. The SYNC includes repeated synchronization symbols, and a quantity of repetitions may be 16, 64, 1024, or 4096. Each synchronization symbol is obtained by performing spreading on a sequence whose length is 31, 91, or 127, and there are a small quantity of sequences with good cross-correlation that are supported on a same channel. The SFD part is a known sequence (currently, the protocol supports two types of sequences). When detecting the SFD sequence, the receiving end knows that the preamble part is about to end and the data part is about to arrive.

The PHR of the data part is usually used to indicate information such as a length of a data field and a data rate. The PHR carries some physical layer indication information, for example, modulation and coding information, a PPDU length, and a receiving end of the PPDU, and is used to assist the receiving end in correctly demodulating data. The PHY payload field carries transmitted data, and a modulation scheme used varies slightly depending on a mean pulse frequency (mean PRF) of a device. A larger mean PRF indicates that the sending end can transmit more pulses in the same time, thereby having a higher transmission rate.

Currently, as a wireless carrier communication technology, an UWB technology transmits data by sending and receiving ultra-narrow pulses in nanoseconds or less instead of using a carrier in a conventional communication system, and modulates different information based on a pulse position and a pulse polarity.

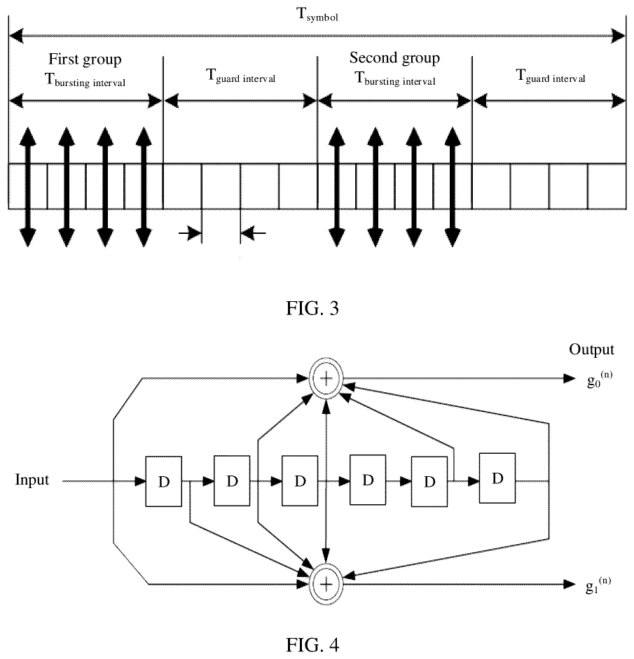

FIG. 3 is a schematic diagram of an example of a transmission interval of a data bit applicable to this application. As shown in FIG. 3, the transmission interval includes two groups of bursting intervals and guard intervals. The bursting interval is used to transmit a pulse to carry an encoded bit, and the guard interval does not transmit any pulse. A bidirectional arrow in the figure indicates a position of a pulse. A current highest mean PRF=249.6 MHz is used as an example. The data bit uses eight pulses to carry two bits after channel coding, each bit occupies four pulses, and each group of four pulses is followed by a guard interval with a time length of the four pulses.

FIG. 4 is a schematic diagram of an example of a structure of a convolutional code encoder whose length is limited to 7 in a UWB system applicable to this application. As shown in FIG. 4, a mean PRF=249.6 MHz is used as an example. Based on a mapping relationship between an output bit and a pulse shown in Table 1, output bits g₀⁽ⁿ⁾ and g₁⁽ⁿ⁾ of the convolutional code encoder are respectively mapped to the two groups of pulses shown in FIG. 3, where 0 corresponds to a positive pulse, and 1 corresponds to a negative pulse.

TABLE 1

| | | First group | Second group |
|---|---|---|---|
| g₀⁽ⁿ⁾ | g₁⁽ⁿ⁾ | of pulses | of pulses |
| 0 | 0 | 0000 | 0000 |
| 1 | 0 | 1111 | 0000 |
| 0 | 1 | 0000 | 1111 |
| 1 | 1 | 1111 | 1111 |

FIG. 5 is a schematic diagram of an example of a structure of a scrambler. As shown in FIG. 5, a scrambling operation may be performed on an encoded bit by using the scrambler. An initial state of the scrambler is the first 15 bits of a binary sequence that is obtained by removing 0 and setting −1 to 0 in a ternary sequence in an SHR. Final code scrambling is completed through an exclusive OR operation, and a scrambled bit is transmitted in a pulse form.

In the UWB system, an existing information modulation scheme has a low rate and cannot carry more bit information, and therefore cannot meet a requirement of a high rate.

Therefore, this application provides a data transmission method and apparatus, to map a to-be-transmitted data bit to a first data bit based on a first mapping relationship, to implement information modulation, thereby improving a data transmission rate and transmission performance of a communication system.

For ease of understanding embodiments of this application, the following descriptions are provided.

In various embodiments of this application, unless otherwise stated or there is a logic conflict, terms and/or descriptions in different embodiments are consistent and may be mutually referenced, and technical features in different embodiments may be combined based on an internal logical relationship thereof, to form a new embodiment.

In embodiments of this application, “at least one” means one or more, and “a plurality of” means two or more. A term “and/or” describes an association relationship between associated objects, and indicates that three relationships may exist. For example, A and/or B may indicate the following three cases: A exists alone, both A and B exist, and B exists alone, where A and B may be singular or plural. In the descriptions of this application, a character “/” usually indicates an “or” relationship between the associated objects. At least one of the following items (pieces) or a similar expression thereof refers to any combination of these items, including any combination of singular items (pieces) or plural items (pieces). For example, at least one of a, b, and c may indicate a, b, c, a and b, a and c, b and c, or a, b, and c, where a, b, and c may be singular or plural.

In embodiments of this application, “first”, “second”, and various numbers are merely used for distinguishing for ease of description, and are not intended to limit the scope of embodiments of this application. For example, the terms are used to differentiate between different indication information.

In embodiments of this application, protocol definition may be implemented by prestoring corresponding code or a corresponding table in a device (for example, an initiating device and a responding device), or in another manner that may be used to indicate related information. A specific implementation is not limited in this application.

Protocols in embodiments of this application may be standard protocols in the communication field, and may include, for example, an LTE protocol, an NR protocol, a WLAN protocol, and a related protocol applied to a future communication system. This is not limited in this application.

In embodiments of this application, descriptions such as “when . . . ”, “in a case of . . . ”, and “if” all mean that the device performs corresponding processing in an objective case, and are not limited to time, and the device is not required to perform a determining action during implementation. This does not mean that there is another limitation.

In embodiments of this application, “being used to indicate” may include “being used to directly indicate” and “being used to indirectly indicate”. When a piece of indication information indicates A, the indication information may directly indicate A or indirectly indicate A, but it does not indicate that the indication information definitely carries A.

The indication manner in embodiments of this application should be understood as covering various methods through which a to-be-indicated party learns of to-be-indicated information. The to-be-indicated information may be sent as a whole, or may be divided into a plurality of pieces of sub-information for separate sending. In addition, sending periodicities and/or sending occasions of the sub-information may be the same or may be different. A specific sending method is not limited in this application.

In embodiments of this application, “wireless communication” may be referred to as “communication” for short. “Communication” may also be described as “data transmission”, “information transmission”, “data processing”, and the like. “Transmission” includes “sending” and “receiving”. This is not specifically limited in this application.

The technical solutions provided in this application are described in detail below with reference to the accompanying drawings.

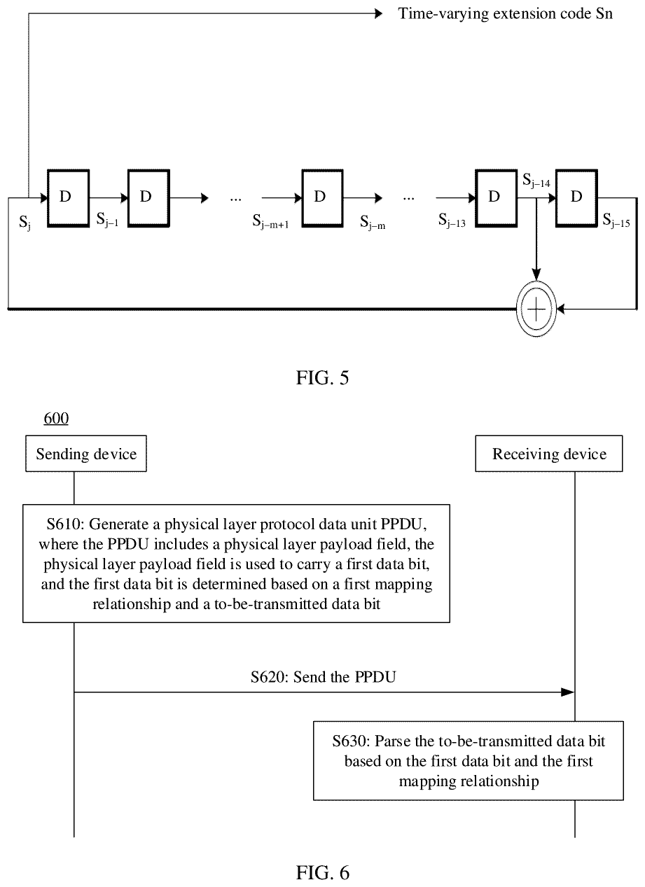

FIG. 6 is a schematic flowchart of a data transmission method 600 according to an embodiment of this application. Implementation steps include S610-S630 described below.

S610: A sending end generates a PPDU.

The PPDU includes a physical layer payload field, the physical layer payload field is used to carry a first data bit, and the first data bit is determined based on a first mapping relationship and a to-be-transmitted data bit.

It should be noted that the PPDU includes two parts: a preamble and data, which are specifically shown in FIG. 2. The preamble part includes a synchronization header SHR, and the data part includes a physical layer header PHR and a PHY payload field. Therefore, before generating the PPDU, the sending end needs to add the preamble part before the data part (namely, the first data bit).

In this embodiment of this application, the first mapping relationship may be predefined. This is not specifically limited in this application.

In this embodiment of this application, the sending end groups every k bits into one group, and there are 2^{k} different bit combinations. For example, if the sending end groups every three bits into one group, there may correspondingly be eight different bit combinations, for example, 000, 001, 010, 011, 100, 101, 110, and 111, namely, the to-be-transmitted data bit. A corresponding first data bit may be obtained after the to-be-transmitted data bit is mapped based on the first mapping relationship.

In a UWB technology, data is transmitted by sending and receiving ultra-narrow pulses in nanoseconds or less. Therefore, in this embodiment of this application, the sending end may carry the first data bit based on a pulse polarity (positive or negative) (for example, 1 corresponds to a positive pulse, and 0 corresponds to a negative pulse), to implement demodulation of the to-be-transmitted data bit.

For example, if the first data bit obtained from the to-be-transmitted data bit 000 based on the first mapping relationship is 10111010, corresponding pulse polarities are positive, negative, positive, positive, positive, negative, positive, and negative. For another example, if the first data bit obtained from the to-be-transmitted data bit 001 based on the first mapping relationship is 10011101, corresponding pulse polarities are positive, negative, negative, positive, positive, positive, negative, and positive; and the like.

It should be noted that the foregoing descriptions are merely examples, and should not constitute any limitation on the technical solutions of this application.

In a possible implementation, the first mapping relationship is determined based on a row of a Hadamard matrix, and the Hadamard matrix is a matrix with n rows and n columns, where
n≥2^{k}, and n is a positive integer. The name of the Hadamard matrix is not specifically limited in this application.

It should be understood that the Hadamard matrix is a square matrix H with n rows and n columns, and has only elements 1 and −1, and all rows of the matrix H are orthogonal to each other. In other words, H*H^{T}=nI, where I is an identity matrix.

In this implementation, the to-be-transmitted data bit is mapped to a row of the Hadamard matrix to obtain n encoded bits, and then elements in the row are mapped to a group of pulse sequences, and transmitted in a pulse form, to finally implement information modulation.

For example, n=8, to be specific, the Hadamard matrix is the square matrix H with eight rows and eight columns. To-be-transmitted data bits (for example, 000, 001, 010, 011, 100, 101, 110, and 111) are separately mapped to each row of the Hadamard matrix, and elements (1 and −1) in each row of the Hadamard matrix are separately mapped to a group of pulse sequences with eight positive and negative pulses, where 1 corresponds to a positive pulse, and −1 corresponds to a negative pulse. The sending end transmits the pulse sequence to carry the first data bit, where in the first data bit, 1 indicates that the pulse polarity is positive, and 0 indicates that the pulse polarity is negative. Correspondingly, a receiving end further parses the to-be-transmitted data bit based on the first data bit and the first mapping relationship.

It should be understood that each to-be-transmitted data bit corresponds to a row of the Hadamard matrix, and elements of the Hadamard matrix to which any two to-be-transmitted data bits are mapped are different.

Optionally, the Hadamard matrix includes a first submatrix, the first submatrix is a circulant matrix with n−1 rows and n−1 columns, elements in an (i+1)^{th} column of the first submatrix are obtained by cyclically shifting elements in an (i)^{th} column to the right by one position in sequence, and i is an integer greater than or equal to 1 and less than or equal to n−2. A row vector of each row of the first submatrix is determined based on a first sequence or an equivalent sequence of a first sequence, and the equivalent sequence is obtained by performing at least one of cyclic shifting, negation, and order reversal on the first sequence.

The first submatrix may be:

$$[ \begin{matrix}{c}_{0} & {c}_{n - 2} & … & {c}_{2} & {c}_{1} \\ {c}_{1} & {c}_{0} & {c}_{n - 2} & … & {c}_{2} \\ ⋮ & ⋮ & ⋱ & ⋮ & ⋮ \\ {c}_{n - 3} & {c}_{n - 4} & … & {c}_{0} & {c}_{n - 2} \\ {c}_{n - 2} & {c}_{n - 3} & … & {c}_{1} & {c}_{0}\end{matrix} ]$$

In this embodiment of this application, the rows of the circulant matrix may include sequences or equivalent sequences thereof shown in the following Table 1 to Table 7. Lengths corresponding to the sequences shown in Table 2 to Table 8 are respectively 3, 7, 11, 15, 19, 23, and 31, which are specifically indicated as:

TABLE 2

| Sequence name | Sequence |
|---|---|
| \vec{C}₁ | 1 −1 1 |

TABLE 3

| Sequence name | Sequence |
|---|---|
| \vec{C}₂ | −1 −1 1 −1 1 1 1 |

TABLE 4

| Sequence name | Sequence |
|---|---|
| \vec{C}₃ | −1 −1 −1 1 −1 1 1 −1 1 1 1 |

TABLE 5

| Sequence name | Sequence |
|---|---|
| \vec{C}₄ | −1 1 −1 1 1 −1 −1 1 −1 −1 −1 1 1 1 1 |

TABLE 6

| Sequence name | Sequence |
|---|---|
| \vec{C}₅ | −1 1 −1 1 −1 −1 −1 −1 1 1 −1 1 1 −1 −1 1 1 1 1 |

TABLE 7

| Sequence name | Sequence |
|---|---|
| \vec{C}₆ | −1 1 −1 1 1 −1 −1 1 1 −1 −1 |
| | 1 −1 1 −1 −1 −1 −1 1 1 1 1 1 |

TABLE 8

| Sequence name | Sequence |
|---|---|
| \vec{C}₇ | −1 −1 1 1 −1 1 −1 −1 1 −1 −1 −1 −1 1 −1 |
| | 1 −1 1 1 1 −1 1 1 −1 −1 −1 1 1 1 1 1 |
| \vec{C}₈ | −1 1 1 −1 −1 1 1 1 −1 −1 −1 −1 1 1 −1 |
| | 1 −1 1 −1 −1 1 −1 −1 −1 1 −1 1 1 1 1 1 |
| \vec{C}₉ | −1 −1 1 −1 −1 1 1 −1 −1 −1 −1 1 −1 1 |
| | 1 −1 1 −1 1 −1 −1 −1 1 1 1 −1 1 1 1 1 1 |

It should be noted that the sequence lengths shown in Table 1 to Table 7 are merely examples for description, and should not constitute any limitation on the technical solutions of this application. In other words, each sequence in the foregoing tables may be replaced with the equivalently deformed sequence of the sequence. For brevity, one or more examples of each sequence length are provided in the technical solutions of this application.

For example, the rows of the circulant matrix may be formed by the sequence whose length is 3 or the equivalent sequence thereof (refer to Table 1). In other words, the sequence \vec{C}₁ is 1 −1 1. Correspondingly, the Hadamard matrix formed by the sequence whose length is 3 may be:

$${H}_{1} = [ \begin{matrix}1 & 1 & 1 & 1 \\ 1 & - 1 & - 1 & 1 \\ 1 & 1 & - 1 & - 1 \\ 1 & - 1 & 1 & - 1\end{matrix} ]$$

For example, the equivalent sequence obtained by performing at least one of cyclic shifting, negation, and order reversal on the circulant matrix may be: 1 −1 −1, −1 1 −1, −1 −1 1, or the like.

For another example, the rows of the circulant matrix may be formed by the sequence whose length is 7 or the equivalent sequence thereof (refer to Table 2). In other words, the sequence \vec{C}₇ is −1 −1 1 −1 1 1 1. Correspondingly, the Hadamard matrix formed by the sequence whose length is 7 may be:

$${H}_{2} = [ \begin{matrix}- 1 & 1 & 1 & 1 & 1 & 1 & 1 & 1 \\ 1 & - 1 & 1 & 1 & 1 & - 1 & 1 & - 1 \\ 1 & - 1 & - 1 & 1 & 1 & 1 & - 1 & 1 \\ 1 & 1 & - 1 & - 1 & 1 & 1 & 1 & - 1 \\ 1 & - 1 & 1 & - 1 & - 1 & 1 & 1 & 1 \\ 1 & 1 & - 1 & 1 & - 1 & - 1 & 1 & 1 \\ 1 & 1 & 1 & - 1 & 1 & - 1 & - 1 & 1 \\ 1 & 1 & 1 & 1 & - 1 & 1 & - 1 & - 1\end{matrix} ]$$

For example, the equivalent sequence obtained by performing at least one of cyclic shifting, negation, and order reversal on the circulant matrix may be: 1 1 1 1 −1 1 −1 −1, 1 1 −1 1 −1 −1 1 1, 1 −1 −1 1 1 1 1 −1 1, or the like.

It should be noted that the equivalent sequences are merely examples for description, and should not constitute any limitation on the technical solutions of this application.

In a possible implementation, the to-be-transmitted data bits 000, 001, 010, 011, 100, 101, 110, and 111 are separately mapped to each row of the Hadamard matrix H₂. In other words, 000 is mapped to a first row −1 1 1 1 1 1 1 1, 001 is mapped to a second row 1 −1 1 1 1 −1 1 −1, 010 is mapped to a third row 1 −1 −1 1 1 1 −1 1, 011 is mapped to a fourth row 1 1 −1 −1 1 1 1 −1, 100 is mapped to a fifth row 1 −1 1 −1 −1 1 1 1, 101 is mapped to a sixth row 1 1 −1 1 −1 −1 1 1, 110 is mapped to a seventh row 1 1 1 −1 1 −1 −1 1, and 111 is mapped to an eighth row 1 1 1 1 −1 1 −1 −1. Then, elements (1 and −1) of each row of the Hadamard matrix are separately mapped to a group of pulse sequences with eight pulses, where 1 corresponds to a positive polarity of the pulse, and −1 corresponds to a negative polarity of the pulse. In this case, the pulse sequence includes the positive pulse and the negative pulse. For example, the to-be-transmitted data bit is 101, and the first data bit corresponding to the to-be-transmitted data bit may be determined as 11010011 based on the first mapping relationship. In this case, the sending end may carry the first data bit by transmitting a group of pulse sequences whose pulse polarities are positive, positive, negative, positive, negative, negative, positive, and positive in sequence, to implement modulation of the to-be-transmitted data bit 101 and improve a transmission rate of a system.

It should be noted that the mapping relationship between the to-be-transmitted data bit and a row of the Hadamard matrix is merely an example for description, and should not constitute any limitation on the technical solutions of this application, provided that it is ensured that the plurality of to-be-transmitted data bits one-to-one correspond to the elements of the rows of the Hadamard matrix.

It should be understood that, when the Hadamard matrix with n rows and n columns has a circulant matrix structure, a submatrix that includes the circulant matrix and that has n rows and n−1 columns may be used as a mapping matrix. In this manner, a quantity of pulses to be transmitted can be further reduced, thereby increasing the transmission rate.

Optionally, in this embodiment of this application, the first mapping relationship may alternatively be determined based on a matrix obtained after the Hadamard matrix is rotated to the right or left by an integer multiple of 90 degrees (namely, kπ, where k is an integer). Therefore, a rotated matrix may also include the first submatrix. This is not specifically limited in this application.

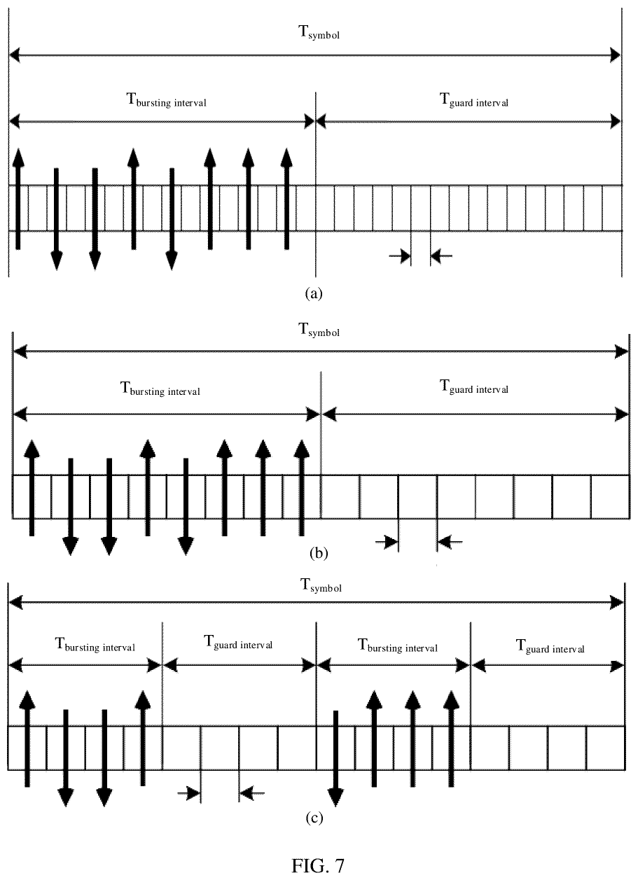

FIG. 7 is a schematic diagram of an example of transmission intervals of data bits that are obtained through mapping of the Hadamard matrix applicable to this application. As shown in (a) in FIG. 7, a transmission interval corresponding to a data bit includes a group of bursting and guard intervals. The bursting interval and the guard interval have a same cycle. For example, elements that are of the Hadamard matrix and that correspond to a to-be-transmitted data bit are 1 −1 −1 1 −1 1 1 1, and are mapped to a group of bursting intervals with eight pulses whose pulse polarities are positive, negative, negative, positive, negative, positive, positive, and positive in sequence, that is, corresponding pulse arrows point to up, down, down, up, down, up, up, and up in sequence. In this implementation, each pulse within a bursting interval occupies ¼ of a signal transmission bandwidth. As shown in (b) in FIG. 7, each pulse within a bursting interval occupies ½ of a signal transmission bandwidth, which is different from (a) in FIG. 7. As shown in (c) in FIG. 7, a difference from (a) and (b) in FIG. 7 lies in that a transmission interval corresponding to a data bit includes two groups of bursting and guard intervals.

It should be understood that the structures of the data symbols shown in FIG. 7 are merely examples for description, and should not constitute any limitation on the technical solutions of this application.

Described another way, the to-be-transmitted data bit is mapped to the first data bit by using the Hadamard matrix, to implement the information modulation, thereby improving the data transmission rate and the transmission performance of the communication system. In addition, through encoding or an orthogonal codeword design, interference between bits of different to-be-transmitted data can be further reduced, and demodulation performance of the system can be enhanced.

In another possible implementation, the first mapping relationship is a specific type of linear block code.

For example, the linear block code includes Hamming code and/or SECDED code.

The Hamming code is linear block error-correcting code. For all integers r greater than or equal to 2, there is code with a code length n=2′−1 and an information bit length k=2′−r−1. There are at least three different bits between any two valid codewords, namely, a minimum code distance. It should be understood that the Hamming code is code with a highest bit rate at a same code distance and of a same code length. In addition, the Hamming code may also be punctured. After puncturing, the code length and the information bit length decrease by a same value, but the code distance remains unchanged, to form new Hamming code (2′−1−m, 2′−r−1−m).

Since the code distance is 3, the Hamming code can correct an error of any bit. However, the Hamming code cannot accurately distinguish whether two bits are incorrect or one bit is incorrect. If there are two error bits and the decoder still corrects the error of only one bit, a decoding result is incorrect. Therefore, a new check bit is introduced based on the Hamming code, so that the code distance is 4, to correct the error of any bit and detect errors in two bits. The code is called the SECDED code.

For example, in this embodiment of this application, the selected linear block code may be (7,4) Hamming code or (8,4) SECDED code, and a generator matrix G corresponding to the linear block code may be:

$${G}_{1} = {[ \begin{matrix}1 & 0 & 0 & 0 & 1 & 1 & 0 \\ 0 & 1 & 0 & 0 & 1 & 0 & 1 \\ 0 & 0 & 1 & 0 & 0 & 1 & 1 \\ 0 & 0 & 0 & 1 & 1 & 1 & 1\end{matrix} ]}_{( 7 , 4 )} or {G}_{2} = {[ \begin{matrix}1 & 0 & 0 & 0 & 0 & 1 & 1 & 1 \\ 0 & 1 & 0 & 0 & 1 & 0 & 1 & 1 \\ 0 & 0 & 1 & 0 & 1 & 1 & 0 & 1 \\ 0 & 0 & 0 & 1 & 1 & 1 & 1 & 0\end{matrix} ]}_{( 8 , 4 )}$$

Then, an encoded data bit x (namely, the first data bit) satisfies:

\vec{x}=\vec{a}G

In other words, the encoded data bit i may be obtained by multiplying a vector \vec{a}=[a₁ a₂ . . . aₙ] (namely, the to-be-transmitted data bit) by the generator matrix G (namely, the first mapping relationship), where aⱼ∈{0,1}, and j is a positive integer greater than or equal to 1 and less than or equal to n. In this implementation, modulo-2 addition is used to encode the data bit. In this case, the finally encoded data bit includes 0 and 1.

Optionally, the sending end transmits the first data bit in the pulse form. Specifically, the encoded data bit \vec{x} is mapped to a group of pulse sequences in a binary phase shift keying (BPSK) manner, and the pulse sequence includes a positive pulse and a negative pulse. The BPSK manner may be understood as that an encoded codeword 0 is mapped to the positive pulse, and a codeword 1 is mapped to the negative pulse.

In a possible implementation, the sending end groups every four bits into one group, and may determine that the to-be-transmitted data bit is d=[a₁ a₂ a₃ a₄] (for example, 0000, 0001, 0010, 0011, 0100, 0101, 0110, 0111, 1000, 1001, 1010, 1011, 1100, 1101, 1110, and 1111). The SECDED code is used as an example. The to-be-transmitted data bits are separately mapped by using the generator matrix G₂ to obtain the encoded data bit \vec{x}. For example, the to-be-transmitted data bit is 1001, and the encoded data bit obtained after the to-be-transmitted data bit is mapped by using the generator matrix G₂ is \vec{x}=[1 0 0 1 1 0 0 1]. Then, the encoded data bit \vec{x}=[1 0 0 1 1 0 0 1] is mapped to a group of pulse sequences in the BPSK manner, where 1 corresponds to a positive pulse, 0 corresponds to a negative pulse, and pulse polarities in the pulse sequence are positive, negative, negative, positive, positive, negative, negative, and positive. In this case, the sending end may carry the encoded data bit (namely, the first data bit) 10011001 by transmitting the pulse sequence, to implement modulation of the to-be-transmitted data bit 1001 and improve the transmission rate of the system. Correspondingly, the receiving end obtains the first data bit by receiving the pulse sequence, and parses, with reference to the first mapping relationship G₂, that the to-be-transmitted data bit is 1001.

It should be understood that the \vec{a}=[1 0 0 1] is merely an example of the to-be-transmitted data bit for description. For brevity, details of another possible implementation are not described herein.

It should be noted that the two types of encoders (the Hamming code and the SECDED code) are merely examples for description, and may further include an encoder of another length or a punctured encoder. This is not specifically limited in this application.

Described another way, the to-be-transmitted data bit is mapped to the first data bit by using the linear block code, to implement the information modulation, thereby improving the data transmission rate and the transmission performance of the communication system. In addition, encoding the to-be-transmitted bit by using the linear block code can further improve an error correction capability and robustness of the system.

Optionally, in this embodiment of this application, the first data bit may be scrambled by using a scrambling code sequence (or a scrambling code bit). The scrambling code sequence (or the scrambling code bit) may be predefined. This is not specifically limited in this application.

For example, one scrambling code bit corresponds to one first data bit. In other words, when the scrambling code bit is 1, all bits in the first data bit are negated.

For example, a scrambling code sequence includes eight scrambling code bits, which are respectively 0 1 1 0 1 0 0 0. First data bits obtained by mapping the to-be-transmitted data bits 000, 001, 010, 011, 100, 101, 110, and 111 based on the first mapping relationship are respectively 10111010, 10011101, 11001110, 10100111, 11010011, 11101001, 11110100, and 01111111. If second, third, and fifth scrambling code bits in the scrambling code sequence are 1, all bits in corresponding second, third, and fifth first data bits are negated. In other words, the second first data bit is changed from 10011101 to 01100010. The third first data bit is changed from 11001110 to 00110001. The fifth first data bit is changed from 11010011 to 00101100.

In this implementation, more data bits may be scrambled by using a small quantity of scrambling code bits, to ensure data transmission security.

Optionally, one scrambling code bit may correspond to one codeword in the first data bit. In other words, when the scrambling code bit is 1, a corresponding bit in the first data bit is negated.

For example, a scrambling code sequence includes eight scrambling code bits, which are respectively 0 1 1 0 1 0 0 0. The first data bit is 10111010, and if second, third, and fifth scrambling code bits in the scrambling code sequence are 1, second, third, and fifth bits in the first data bit are negated. In other words, the first data bit is changed from 10111010 to 11010010.

It should be noted that the foregoing descriptions are merely examples, and should not constitute any limitation on the technical solutions of this application.

S620: The sending end sends the PPDU to the receiving end.

Correspondingly, the receiving end receives the PPDU from the sending end.

For example, when the to-be-transmitted data bit is 010, the first data bit may be determined as 1 0 0 1 1 1 0 1 based on the first mapping relationship in step S610 (for example, determined based on a row of the Hadamard matrix), where I corresponds to a positive pulse, and 0 corresponds to a negative pulse. In this case, the sending end may indicate the encoded data bit, namely, the first data bit, by transmitting a group of pulse sequences whose pulse polarities are positive, negative, negative, positive, positive, positive, negative, and positive. The receiving end may obtain the corresponding first data bit based on the pulse sequence, and further parse, based on the first mapping relationship, that the to-be-transmitted data bit is 010, to implement modulation, receiving, and sending of the to-be-transmitted data bit.

For example, when the to-be-transmitted data bit is 1101, the first data bit may be determined as 1 1 0 1 0 0 1 0 based on the first mapping relationship in step S610 (for example, the (8,4) SECDED code), where 1 corresponds to a positive pulse, and 0 corresponds to a negative pulse. In this case, the sending end may indicate the encoded data bit, namely, the first data bit, by transmitting a group of pulse sequences whose pulse polarities are positive, positive, negative, positive, negative, negative, positive, and negative. The receiving end may obtain the corresponding first data bit based on the pulse sequence, and further parse, based on the first mapping relationship, that the to-be-transmitted data bit is 1101, to implement modulation, receiving, and sending of the to-be-transmitted data bit.

It should be noted that the foregoing descriptions are merely examples, and should not constitute any limitation on the technical solutions of this application.

It should be understood that the PPDU includes the two parts: the preamble and the data. Therefore, before generating the PPDU, the sending end needs to add the preamble part (for example, the SHR) before the data part (namely, the first data bit).

S630: The receiving end parses the to-be-transmitted data bit based on the first data bit and the first mapping relationship.

For a specific parsing manner, refer to the existing description. This is not specifically limited in this application.

For example, the receiving end receives and detects the PPDU, to obtain the first data bit, and parses the to-be-transmitted data bit based on the first mapping relationship. For example, when the first mapping relationship is determined based on a row of the Hadamard matrix, the receiving end may further determine, based on the received first data bit 1 0 0 1 1 1 0 1 and the first mapping relationship, that the to-be-transmitted data bit is 010. For another example, when the first mapping relationship is a specific type of linear block code (for example, the generator matrix G₂ determined based on the SECDED code), the receiving end may further determine, based on the received first data bit 1 1 0 1 0 0 1 0 and the first mapping relationship, that the to-be-transmitted data bit is 1101.

It should be noted that the foregoing descriptions are merely examples, and should not constitute any limitation on the technical solutions of this application.

According to the solution provided in this application, the sending end obtains the first data bit by mapping the to-be-transmitted data bit based on the first mapping relationship, and encodes different to-be-transmitted data bits based on the first mapping relationship, to implement the information modulation, thereby improving the data transmission rate and the transmission performance of the communication system.

It should be noted that embodiments of this application may be applied to a plurality of different scenarios, including the scenario shown in FIG. 1, but is not limited to the scenario. For example, for uplink transmission, the FFD may serve as the sending end, and the RFD may serve as the receiving end. For downlink transmission, the FFD may serve as the sending end, and the RFD may serve as the receiving end. For another transmission scenario, for example, data transmission between the FFDs, one FFD may serve as the sending end, and the other FFD may serve as the receiving end.

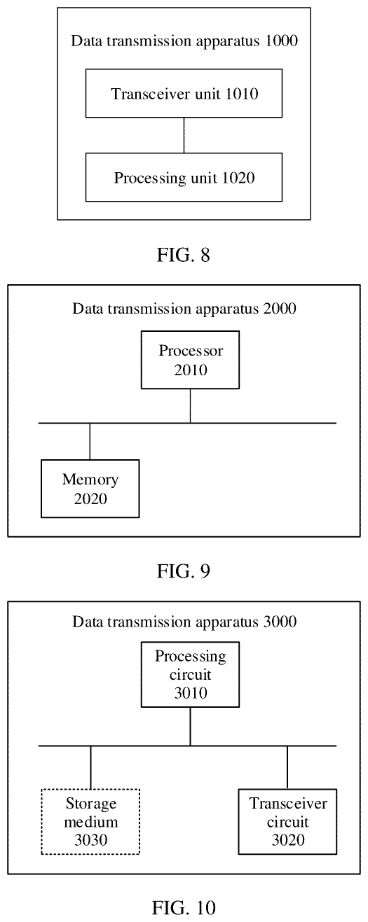

The foregoing describes in detail embodiments of the data transmission method side in this application with reference to FIG. 1 to FIG. 7, and the following describes in detail embodiments of the data transmission apparatus side in this application with reference to FIG. 8 to FIG. 10. It should be understood that descriptions of the apparatus embodiments correspond to the descriptions of the method embodiments. Therefore, for a part that is not described in detail, refer to the foregoing method embodiments.

FIG. 8 is a schematic block diagram of a data transmission apparatus according to an embodiment of this application. As shown in FIG. 8, the apparatus 1000 includes a transceiver unit 1010 and a processing unit 1020. The transceiver unit 1010 may communicate with the outside, and the processing unit 1020 is configured to perform data processing. The transceiver unit 1010 may also be referred to as a communication interface or a communication unit.

In a possible design, the apparatus 1000 may implement the steps or procedures performed by the sending end in the foregoing method embodiments. The processing unit 1020 is configured to perform processing-related operations performed by the sending end in the foregoing method embodiments. The transceiver unit 1010 is configured to perform receiving/sending-related operations performed by the sending end in the foregoing method embodiments.

For example, the processing unit 1020 is configured to generate a PPDU, where the PPDU includes a physical layer payload field, the physical layer payload field is used to carry a first data bit, and the first data bit is determined based on a first mapping relationship and a to-be-transmitted data bit.

The transceiver unit 1010 is configured to send the PPDU.

Optionally, the first mapping relationship is determined based on a row of a Hadamard matrix, and the Hadamard matrix is a matrix with n rows and n columns.

Further, the Hadamard matrix includes a first submatrix, the first submatrix is a circulant matrix with n−1 rows and n−1 columns, elements in an (i+1)^{th} column of the first submatrix are obtained by cyclically shifting elements in an (i)^{th} column to the right by one position in sequence, and i is an integer greater than or equal to 1 and less than or equal to n−2; and a row vector of each row of the first submatrix is determined based on a first sequence or an equivalent sequence of a first sequence, and the equivalent sequence is obtained by performing at least one of cyclic shifting, negation, and order reversal on the first sequence.

Optionally, the first mapping relationship is a specific type of linear block code.

For example, the linear block code includes Hamming code and/or single error correction and double error detection SECDED code.

Optionally, the processing unit 1020 is further configured to: when a scrambling code bit is 1, negate all bits in the first data bit.

In another possible design, the apparatus 1000 may implement the steps or procedures performed by the receiving end in the foregoing method embodiments. The transceiver unit 1010 is configured to perform receiving/sending-related operations performed by the receiving end in the foregoing method embodiments. The processing unit 1020 is configured to perform processing-related operations performed by the receiving end in the foregoing method embodiments.

For example, the transceiver unit 1010 is configured to receive a physical layer protocol data unit PPDU, where the PPDU includes a physical layer payload field, the physical layer payload field is used to carry a first data bit, and the first data bit is determined based on a first mapping relationship and a to-be-transmitted data bit.

The processing unit 1020 is configured to parse the to-be-transmitted data bit based on the first data bit and the first mapping relationship.

Optionally, the first mapping relationship is determined based on a row of a Hadamard matrix, and the Hadamard matrix is a matrix with n rows and n columns.

Further, the Hadamard matrix includes a first submatrix, the first submatrix is a circulant matrix with n−1 rows and n−1 columns, elements in an (i+1)^{th} column of the first submatrix are obtained by cyclically shifting elements in an (i)^{th} column to the right by one position in sequence, and i is an integer greater than or equal to 1 and less than or equal to n−2; and a row vector of each row of the first submatrix is determined based on a first sequence or an equivalent sequence of a first sequence, and the equivalent sequence is obtained by performing at least one of cyclic shifting, negation, and order reversal on the first sequence.

Optionally, the first mapping relationship is a specific type of linear block code.

For example, the linear block code includes Hamming code and/or SECDED code.

Optionally, the processing unit 1020 is further configured to: when a scrambling code bit is 1, negate all bits in the first data bit.

It should be understood that the apparatus 1000 herein is embodied in a form of a functional unit. The term “unit” herein may refer to an application-specific integrated circuit (ASIC), an electronic circuit, a processor (for example, a shared processor, a dedicated processor, or a group processor) configured to execute one or more software or firmware programs, a memory, a merged logic circuit, and/or another appropriate component that supports the described function. In an optional example, a person skilled in the art may understand that, the apparatus 1000 may be specifically the sending end in the foregoing embodiments, and may be configured to perform the procedures and/or steps corresponding to the sending end in the foregoing method embodiments. Alternatively, the apparatus 1000 may be specifically the receiving end in the foregoing embodiments, and may be configured to perform the procedures and/or steps corresponding to the receiving end in the foregoing method embodiments. To avoid repetition, details are not described herein again in relation to FIG. 8.

The apparatus 1000 in each of the foregoing solutions has a function of implementing the corresponding steps performed by the sending end in the foregoing method, or the apparatus 1000 in each of the foregoing solutions has a function of implementing the corresponding steps performed by the receiving end in the foregoing method. The function may be implemented by hardware or may be implemented by hardware executing corresponding software. The hardware or the software includes one or more modules corresponding to the foregoing functions. For example, the transceiver unit may be replaced with a transceiver (for example, a sending unit in the transceiver unit may be replaced with a transmitter, and a receiving unit in the transceiver unit may be replaced with a receiver). Another unit, such as a processing unit, may be replaced with a processor to separately perform sending and receiving operations and a related processing operation in each method embodiment.

In addition, the transceiver unit may alternatively be a transceiver circuit (for example, may include a receiving circuit and a sending circuit), and the processing unit may be a processing circuit. In this embodiment of this application, the apparatus in FIG. 8 may be the receiving end or the sending end in the foregoing embodiments, or may be a chip or a chip system, for example, a system on chip (SoC). The transceiver unit may be an input/output circuit or a communication interface. The processing unit is a processor, a microprocessor, or an integrated circuit integrated on the chip. This is not limited herein.

FIG. 9 shows a data transmission apparatus 2000 according to an embodiment of this application. The apparatus 2000 includes a processor 2010 and a memory 2020. The memory 2020 is configured to store instructions. The processor 2010 may invoke the instructions stored in the memory 2020, to perform the procedures and steps corresponding to the sending end in the foregoing method embodiments.

In another possible implementation, the memory 2020 is configured to store instructions, and the processor 2010 may invoke the instructions stored in the memory 2020, to perform the procedures and steps corresponding to the receiving end in the foregoing method embodiments.

It should be understood that, the apparatus 2000 may be specifically the sending end or the receiving end in the foregoing embodiments, or may be a chip or a chip system. Specifically, the apparatus 2000 may be configured to perform the steps and/or procedures corresponding to the sending end or the receiving end in the foregoing method embodiments.

Optionally, the memory 2020 may include a read-only memory and a random access memory, and provide the instructions and data for the processor. A part of the memory may further include a non-volatile random access memory. For example, the memory may further store information of a device type. The processor 2010 may be configured to execute the instructions stored in the memory. When the processor 2010 executes the instructions stored in the memory, the processor 2010 is configured to perform the steps and/or procedures in the method embodiments corresponding to the sending end or the receiving end.

In an implementation process, the steps in the foregoing methods can be implemented by using a hardware integrated logical circuit in the processor or by using instructions in a form of software. The steps of the methods disclosed with reference to embodiments of this application may be directly performed and completed by a hardware processor, or may be performed and completed by a combination of hardware and a software module in the processor. The software module may be located in a mature storage medium in the art, for example, a random access memory, a flash memory, a read-only memory, a programmable read-only memory, an electrically erasable programmable memory, or a register. The storage medium is located in the memory, and the processor reads information in the memory and completes the steps in the foregoing methods in combination with hardware of the processor. To avoid repetition, details are not described herein again in relation to FIG. 9.

It should be noted that the processor in this embodiment of this application may be an integrated circuit chip, and has a signal processing capability. In the implementation process, the steps in the foregoing method embodiments can be implemented by using the hardware integrated logical circuit in the processor, or by using the instructions in the form of software. The processor may be a general-purpose processor, a digital signal processor, an application-specific integrated circuit, a field programmable gate array or another programmable logic device, a discrete gate or a transistor logic device, or a discrete hardware component. The processor in this embodiment of this application may implement or perform the methods, the steps, and the logical block diagrams that are disclosed in embodiments of this application. The general-purpose processor may be a microprocessor, or the processor may be any conventional processor, or the like. The steps of the methods disclosed with reference to embodiments of this application may be directly performed and completed by a hardware decoding processor, or may be performed and completed by using a combination of hardware and software modules in the decoding processor. The software module may be located in a mature storage medium in the art, for example, a random access memory, a flash memory, a read-only memory, a programmable read-only memory, an electrically erasable programmable memory, or a register. The storage medium is located in the memory, and the processor reads information in the memory and completes the steps in the foregoing methods in combination with hardware of the processor.

It may be understood that the memory in this embodiment of this application may be a volatile memory or a nonvolatile memory, or may include both a volatile memory and a nonvolatile memory. The nonvolatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM), and is used as an external cache. Through example but not limitative descriptions, many forms of RAMs may be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM). It should be noted that the memory of the systems and methods described in this specification includes but is not limited to these memories and any memory of another proper type.

FIG. 10 shows a data transmission apparatus 3000 according to an embodiment of this application. The apparatus 3000 includes a processing circuit 3010 and a transceiver circuit 3020. The processing circuit 3010 and the transceiver circuit 3020 communicate with each other through an internal connection path. The processing circuit 3010 is configured to execute instructions to control the transceiver circuit 3020 to send a signal and/or receive a signal.

Optionally, the apparatus 3000 may further include a storage medium 3030, and the storage medium 3030 communicates with the processing circuit 3010 and the transceiver circuit 3020 through internal connection paths. The storage medium 3030 is configured to store instructions, and the processing circuit 3010 may execute the instructions stored in the storage medium 3030.

In a possible implementation, the apparatus 3000 is configured to implement the procedures and steps corresponding to the sending end in the foregoing method embodiments.

In another possible implementation, the apparatus 3000 is configured to implement the procedures and steps corresponding to the receiving end in the foregoing method embodiments.

According to the method provided in embodiments of this application, this application further provides a computer program product. The computer program product includes computer program code. When the computer program code is run on a computer, the computer is enabled to perform the method in the embodiment shown in FIG. 6.

According to the method provided in embodiments of this application, this application further provides a computer-readable medium. The computer-readable medium stores program code. When the program code is run on a computer, the computer is enabled to perform the method in the embodiment shown in FIG. 6.

According to the method provided in embodiments of this application, this application further provides a system, including the one or more stations and the one or more access points.

A person of ordinary skill in the art may be aware that units and algorithm steps described with reference to embodiments disclosed in this specification can be implemented by electronic hardware, or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

A person skilled in the art may clearly understand that, for convenient and brief description, for a detailed working process of the foregoing system, apparatus, and unit, refer to a corresponding process in the foregoing method embodiments. Details are not described herein again in relation to FIG. 10.

In the several embodiments provided in this application, it should be understood that the disclosed system, apparatus, and method may be implemented in other manners. For example, the described apparatus embodiments are merely examples. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate components may or may not be physically separate, and components displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units may be integrated into one unit.

When the functions are implemented in a form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in embodiments of this application. The foregoing storage medium includes any medium that can store program code, for example, a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A data transmission method, comprising:
generating, by a data transmission apparatus, a physical layer protocol data unit (PPDU), wherein the PPDU comprises a physical layer payload field for carrying a first data bit, and the first data bit is determined based on a first mapping relationship and a to-be-transmitted data bit; and
sending, via a network interface of the data transmission apparatus, the PPDU.

2. The method according to claim 1, wherein
the first mapping relationship is determined based on a row of a Hadamard matrix, and the Hadamard matrix is a matrix with n rows and n columns.

3. The method according to claim 2, wherein
the Hadamard matrix comprises a first submatrix, the first submatrix is a circulant matrix with n−1 rows and n−1 columns, elements in an (i+1)^{th} column of the first submatrix are obtained by cyclically shifting elements in an (i)^{th} column to the right by one position in sequence, and i is an integer greater than or equal to 1 and less than or equal to n−2; and
a row vector of each row of the first submatrix is determined based on a first sequence or an equivalent sequence of a first sequence, and, when the row vector of each row of the first submatrix is determined based on the equivalent sequence of the first sequence, the equivalent sequence is obtained by performing at least one of cyclic shifting, negation, and order reversal on the first sequence.

4. The method according to claim 1, wherein the first mapping relationship is a specific type of linear block code.

5. The method according to claim 4, wherein the linear block code comprises Hamming code and/or single error correction and double error detection (SECDED) code.

6. A data receiving method, comprising:
receiving, via a network interface of a data receiving apparatus, a physical layer protocol data unit (PPDU), wherein the PPDU comprises a physical layer payload field for carrying a first data bit, and the first data bit is determined based on a first mapping relationship and a to-be-transmitted data bit; and
parsing, by the data receiving apparatus, the to-be-transmitted data bit based on the first data bit and the first mapping relationship.

7. The method according to claim 6, wherein
the first mapping relationship is determined based on a row of a Hadamard matrix, and the Hadamard matrix is a matrix with n rows and n columns.

8. The method according to claim 7, wherein
the Hadamard matrix comprises a first submatrix, the first submatrix is a circulant matrix with n−1 rows and n−1 columns, elements in an (i+1)^{th} column of the first submatrix are obtained by cyclically shifting elements in an (i)^{th} column to the right by one position in sequence, and i is an integer greater than or equal to 1 and less than or equal to n−2; and
a row vector of each row of the first submatrix is determined based on a first sequence or an equivalent sequence of a first sequence, and, when the row vector of each row of the first submatrix is determined based on the equivalent sequence of the first sequence, the equivalent sequence is obtained by performing at least one of cyclic shifting, negation, and order reversal on the first sequence.

9. The method according to claim 6, wherein the first mapping relationship is a specific type of linear block code.

10. The method according to claim 9, wherein the linear block code comprises Hamming code and/or single error correction and double error detection (SECDED) code.

11. A data transmission apparatus, comprising:
a non-volatile memory storage comprising instructions; and
one or more processors in communication with the memory, wherein the one or more processors execute the instructions to:
generate a physical layer protocol data unit (PPDU), wherein the PPDU comprises a physical layer payload field for carrying a first data bit, and the first data bit is determined based on a first mapping relationship and a to-be-transmitted data bit; and
send the PPDU.

12. The apparatus according to claim 11, wherein
the first mapping relationship is determined based on a row of a Hadamard matrix, and the Hadamard matrix is a matrix with n rows and n columns.

13. The apparatus according to claim 12, wherein
the Hadamard matrix comprises a first submatrix, the first submatrix is a circulant matrix with n−1 rows and n−1 columns, elements in an (i+1)^{th} column of the first submatrix are obtained by cyclically shifting elements in an (i)^{th} column to the right by one position in sequence, and i is an integer greater than or equal to 1 and less than or equal to n−2; and
a row vector of each row of the first submatrix is determined based on a first sequence or an equivalent sequence of a first sequence, and, when the row vector of each row of the first submatrix is determined based on the equivalent sequence of the first sequence, the equivalent sequence is obtained by performing at least one of cyclic shifting, negation, and order reversal on the first sequence.

14. The apparatus according to claim 11, wherein the first mapping relationship is a specific type of linear block code.

15. The apparatus according to claim 14, wherein the linear block code comprises Hamming code and/or single error correction and double error detection (SECDED) code.

16. A data receiving apparatus, comprising:
a transceiver unit, configured to receive a physical layer protocol data unit (PPDU), wherein the PPDU comprises a physical layer payload field for carrying a first data bit, and the first data bit is determined based on a first mapping relationship and a to-be-transmitted data bit; and
a processing unit, configured to parse, the to-be-transmitted data bit based on the first data bit and the first mapping relationship.

17. The apparatus according to claim 16, wherein
the first mapping relationship is determined based on a row of a Hadamard matrix, and the Hadamard matrix is a matrix with n rows and n columns.

18. The apparatus according to claim 17, wherein
the Hadamard matrix comprises a first submatrix, the first submatrix is a circulant matrix with n−1 rows and n−1 columns, elements in an (i+1)^{th} column of the first submatrix are obtained by cyclically shifting elements in an (i)^{th} column to the right by one position in sequence, and i is an integer greater than or equal to 1 and less than or equal to n−2; and
a row vector of each row of the first submatrix is determined based on a first sequence or an equivalent sequence of a first sequence, and, when the row vector of each row of the first submatrix is determined based on the equivalent sequence of the first sequence, the equivalent sequence is obtained by performing at least one of cyclic shifting, negation, and order reversal on the first sequence.

19. The apparatus according to claim 16, wherein the first mapping relationship is a specific type of linear block code.

20. The apparatus according to claim 19, wherein the linear block code comprises Hamming code and/or single error correction and double error detection (SECDED code).
